(19) United States
(12) Patent Application Publication
(10) Pub. No.: US 2014/0195559 A1
(43) Pub. Date: Jul. 10, 2014

(54) NETWORK DEVICE, CONTROLLER FOR CONTROLLING NETWORK DEVICE, AND NETWORK CONTROL SYSTEM

(71) Applicant: Electronics & Telecommunications Research Institute, Daejeon (KR)

(72) Inventors: Seok Kap KO, Gwangju (KR); Hong Yeon YU, Gwangju (KR); Il Kyun PARK, Gwangju (KR); Byung Tak LEE, Gyeonggi-do (KR); Young Sun KIM, Daejeon (KR)

(21) Appl. No.: 13/921,235

(22) Filed: Jun. 19, 2013

(30) Foreign Application Priority Data
Jan. 10, 2013 (KR) 10-2013-0002776

(51) Int. Cl. G06F 17/30

(52) U.S. Cl. CPC G06F 17/30477
USPC 707/770

(57) ABSTRACT

Provided are a network device, a controller for controlling at least one network device constituting a software-defined network (SDN), and a network control system. The network control system includes at least one event processing network connected to a central server. The central server is configured to give each of the event processing network an event condition and an instruction describing an operation according to the event condition, and each of the event processing network is configured to analyze sensor data of the event processing network itself or a message received from a surrounding event processing network on the basis of the instruction given by the central server, and perform the operation according to the event condition when the event condition is satisfied.

### CLAIM FOR PRIORITY

This application claims priority to Korean Patent Application No. 10-2013-0002776 filed on Jan. 10, 2013 in the Korean Intellectual Property Office (KIPO), the entire contents of which are hereby incorporated by reference.

### BACKGROUND

1. Technical Field

Example embodiments of the present invention relate in general to a network control system based on continuous query language (CQL), and more particularly, to a network device, a controller for controlling at least one network device constituting a software-defined network (SDN), and a network control system for event processing and routing using CQL.

2. Related Art

In a production line or an integrated control system in which many sensors are widely installed, respective sensor nodes forward sensor data sensed by the sensors to a server, and the server analyzes the received data and performs operation, for example, stop of a machine operation, issue of an alert, and cut-off of gas supply, necessary according to the analysis results.

In such an existing constitution, media conversion and protocol conversion processes cause a delay while sensor data is collected by a server, and also a delivery delay occurs in a network path. In addition, since an analysis is carried out after data is collected by a server, a delay in processing time may occur depending on the load of the server. Unless emergencies in a production line and an integrated control system are rapidly handled, serious loss such as defective products, breakdowns, and fires may occur. In particular, when a fault occurs in a server or there is a trouble in a forwarding path to the server, the event may not be properly processed and a serious problem may occur.

To solve such a problem, a function of analyzing data is assigned in a distributed manner, and a sensor gateway directly connected to a plurality of sensors functions to analyze data such that a server may give an instruction for the sensor gateway to analyze data in a specific way in a Sensor Web.

However, using such an existing method, it is possible to take a control only to a simple level of condition comparison, etc., and various data analysis methods such as complicated calculation, processing of a function, and designation of a time range cannot be described to control. In addition, when there are a large number of sensor nodes, the number of hardware sensor gateways increases, and thus installation and management cost also increases.

### SUMMARY

Accordingly, example embodiments of the present invention are provided to substantially obviate one or more problems due to limitations and disadvantages of the related art.

Example embodiments of the present invention provide a network control system capable of processing a complex event without causing a delay.

Example embodiments of the present invention also provide a network device capable of processing a complex event without causing a delay.

Example embodiments of the present invention also provide a controller capable of processing a complex event without causing a delay.

In some example embodiments, a network control system includes at least one event processing network connected to a central server. The central server gives each of the event processing network an event condition and an instruction describing an operation according to the event condition, and each of the event processing network is configured to analyze sensor data of the event processing network itself or a message received from a surrounding event processing network on the basis of the instruction given by the central server, and perform the operation according to the event condition when the event condition is satisfied.

Here, each of the event processing network may include a network device, at least one sensor node configured to forward sensor data sensed by a sensor to the network device, and an actuator configured to operate according to a received message, and the network device may be configured to analyze the sensor data received from the sensor node or a message received from a surrounding network device on the basis of the instruction from the central server, and generate an operation message according to the event condition and forward the generated message to the actuator or the surrounding network device when the event condition is satisfied.

Here, the instruction given to the event processing network by the central server may be a continuous query language (CQL)-based message.

Here, the network control system may further include a controller configured to forward a CQL-based query message from the central server to each of the event processing network.

In other example embodiments, a network device includes: a query list manager, a packet-stream converter, a query inquiry unit, a logical calculator, and an operation performer. The query list manager is configured to receive a CQL-based query message from a central server through a controller, store the received CQL-based query message in a memory, and manage the stored CQL-based query message in a query list, the packet-stream converter is configured to decode a packet input through an input interface, the query inquiry unit is configured to acquire a query message corresponding to the decoded packet through the query list manager, the logical calculator is configured to perform a logical calculation for determining an operation according to a condition specified in the acquired query message, and the operation performer is configured to perform the operation according to the logical calculation result.

Here, the packet-stream converter may perform application layer decoding for the packet using the query list and identify a stream identification (ID) from header information of the decoded packet, and the query inquiry unit may acquire the query message corresponding to the stream ID through the query list manager.

Here, the operation performer may perform an operation of generating a message according to the logical calculation result or reconfiguring the packet, and transmitting the generated message or the reconfigured packet to an actuator or a surrounding network device through an output interface.

Here, the network device may further include an event timer, and the query list manager may reset the event timer on the basis of the query message received through the controller.

Here, the network device may further include a filter manager and a network switching engine, and the filter manager may be configured to add a packet filter in front of the network switching engine when a packet filter addition request is received from the query list manager, such that the packet input through the input interface passes the network switching engine to an output interface when the packet does not accord with the packet filter.

In other example embodiments, a controller for controlling at least one network device constituting a software-defined network (SDN) sets an optimal path from a first host to a second host and gives a CQL-based instruction to respective network devices on the optimal path when a request for a path from the first host to the second host is received. The controller is configured to identify network devices closest to the respective network devices on the optimal path, and give the respective network devices an instruction to transmit a packet having the first host as a source address and the second host as a destination address to the identified closest network devices when the packet is received.

Here, each of the network devices may include a query list manager, a query-network transmission rule converter, a packet forwarding table, a routing table, and a network switching engine. The packet forwarding table may be configured to store next destination information on a packet received through an input interface, the query list manager may be configured to receive the CQL-based instruction from the controller and manage the CQL-based instruction in a query list, the query-network transmission rule converter may be configured to receive a query sentence from the query list manager, convert the query into a network transmission rule, and cause the packet forwarding table to reflect the network transmission rule, and the network switching engine may be configured to process the packet with reference to the packet forwarding table and the routing table.

Here, when a virtual local area network (VLAN) is configured, each of the network devices may further include a VLAN table configured to store VLAN configuration information for determining a tagging and forwarding path, and the network switching engine may process the packet with reference to the VLAN table as well.

Here, the controller may be configured to receive an event condition and an instruction describing an operation according to the event condition from a central server, and forward the received instruction to each of the network devices, such that each of the network devices analyzes sensor data of the network device itself or a message received from each surrounding network device on the basis of the instruction received through the controller and performs the operation according to the event condition when the event condition is satisfied.

### BRIEF DESCRIPTION OF DRAWINGS

Example embodiments of the present invention will become more apparent by describing in detail example embodiments of the present invention with reference to the accompanying drawings, in which:

FIG. 1 is a block diagram of a network control system according to an example embodiment of the present invention;

FIG. 2 is a block diagram of a network device for processing a complex event according to an example embodiment of the present invention;

FIG. 3 is a block diagram of a network device for processing a complex event according to another example embodiment of the present invention;

FIG. 4 is a conceptual diagram illustrating operation of a controller that controls network devices constituting a software-defined network (SDN) according to an example embodiment of the present invention;

FIG. 5 is a block diagram of a network device constituting an SDN according to the example embodiment of FIG. 4; and

FIG. 6 is a block diagram of a network device constituting an SDN according to an example embodiment of the present invention.

### DESCRIPTION OF EXAMPLE EMBODIMENTS OF THE PRESENT INVENTION

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims. Elements of the example embodiments are consistently denoted by the same reference numerals throughout the drawings and detailed description.

It will be understood that, although the terms first, second, A, B, etc. may be used herein in reference to elements of the invention, such elements should not be construed as limited by these terms. For example, a first element could be termed a second element, and a second element could be termed a first element, without departing from the scope of the present invention. Herein, the term “and/or” includes any and all combinations of one or more referents.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” etc.).

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, components, and/or groups thereof, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

Hereinafter, example embodiments of the present invention will be described in detail with reference to the accompanying drawings. To aid in understanding the present invention, like numbers refer to like elements throughout the description of the figures, and the description of the same component will not be reiterated.

In the case of a production pipeline consisting of successive stages, various sensors such as a temperature sensor, a humidity sensor, a light amount sensor, and a gas sensor are attached to each production line and continuously carry out measurement, and a sensor node converts measured sensor data into a form that can be transmitted to a network and transmits the converted sensor data to a server. According to the related art, network switches on a path forward a packet containing measured sensor data to the server as it is, but in a complex event processing system according to an example embodiment of the present invention, a network device can autonomously process an event. Description will be made below with reference to drawings.

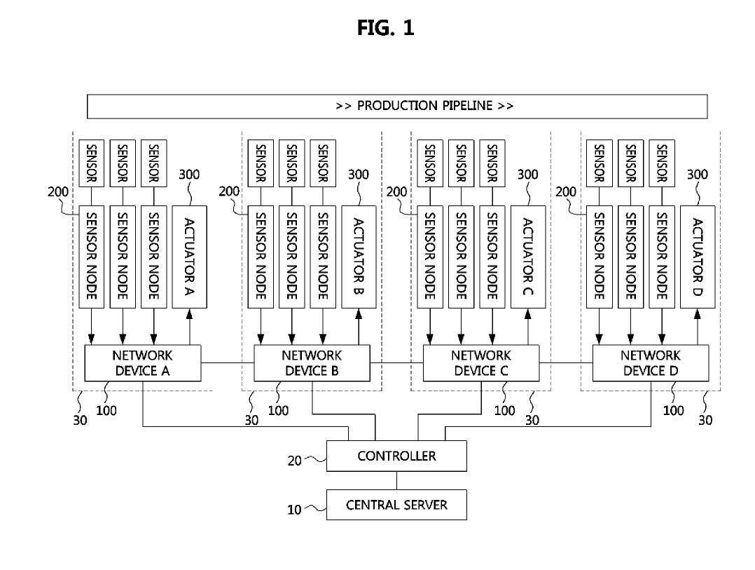

FIG. 1 is a block diagram of a network control system according to an example embodiment of the present invention.

FIG. 1 shows a constitution of a network control system that can be applied to a production pipeline consisting of successive stages. A variety of sensors such as a temperature sensor, a humidity sensor, a light amount sensor, and a gas sensor are attached to each production line and continuously carry out measurement.

In such an environment, a network control system according to an example embodiment of the present invention may include a central server 10, a controller 20 connected to the central server 10, and a plurality of event processing network 30. Here, the controller 20 is a logical module, and may be located in the central server 10 in terms of an actual physical constitution.

Referring to FIG. 1, the detailed constitution of the network control system according to an example embodiment of the present invention may be described as follows.

The central server 10 forwards an event condition configured as a continuous query language (CQL)-based query message and an instruction describing an operation according to the event condition to the controller 20, and the controller 20 forwards the instruction received from the central server 10 to the respective event processing networks 30.

Accordingly, each of the event processing networks 30 may be configured to analyze sensor data in the event processing network 30 itself or a message received from a surrounding event processing network 30 on the basis of the instruction received from the central server 10 through the controller 20, and perform the operation according to the event condition when the event condition is satisfied.

Here, CQL has a similar form to structured query language (SQL) used in a relational database. While SQL describes an operation of taking data out of a storage such as a hard disk drive (HDD) and finding data satisfying a desired condition, CQL describes a rule for finding data satisfying a desired condition in a data stream continuously flowing in. A CQL-based instruction may be CQL in the form of text and encoded in the form of eXtensible Markup Language (XML) or in a binary form, and the meaning of the message corresponds to CQL.

Referring to FIG. 1, each of the event processing networks 30 may include a network device 100, at least one sensor node 200, and an actuator 300, and operation of the respective components and relationships between the components may be described as follows.

Each sensor node 200 connected to a sensor forwards sensor data sensed through the sensor to the network device 100, and the network device 100 analyzes the sensor data received from the sensor node 200 or a message received from a surrounding network device 100 on the basis of the instruction given by the central server 10 through the controller 20, that is, the event condition and the instruction describing the operation according to the event condition, and operates in cooperation with the surrounding network device 100 when the event condition is satisfied. In other words, the network device 100 may be configured to generate an operation message corresponding to the event condition and forward the generated operation message to the actuator 300 or the surrounding network device 100.

For example, when a problem occurs in a production line, network device A 100 analyzes data measured by a sensor node 200, and immediately generates and transmits a message to surrounding network device B 100 when it is determined as the analysis result that there is a probability of an increasing defect rate. Meanwhile, network device B 100 may analyze the message received from network device A 100 and sensor data collected from each sensor node 200 connected to network device B 100 itself, and generate and transmit a message containing an instruction to remove a defective product to actuator B 300 when it is determined that the defective product has been produced. Accordingly, actuator B 300 performs an operation of removing the defective product.

In this way, the network device 100 according to an example embodiment of the present invention may perform a function of analyzing data and taking an action according to the analysis result in addition to a basic packet-forwarding function.

A constitution of a network device according to an example embodiment of the present invention will be described in further detail below.

In general, when a packet is input to an input interface (port), network equipment such as a network router and a switch determines a destination port and transmits the packet to the destination port. However, a network device 100 according to an example embodiment of the present invention converts such a packet into a data stream and processes an event.

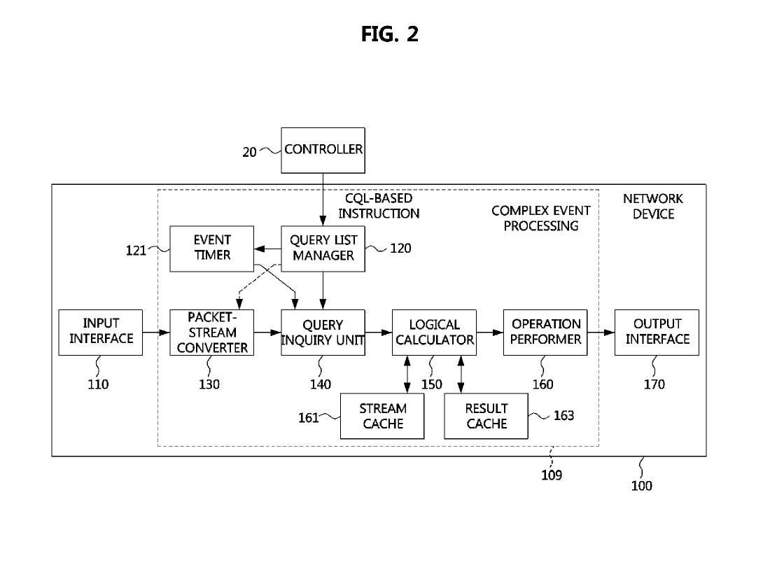

FIG. 2 is a block diagram of a network device for processing a complex event according to an example embodiment of the present invention.

Referring to FIG. 2, a network device 100 for processing a complex event according to an example embodiment of the present invention is connected to a controller 20 to receive a CQL-based query message. Here, the controller 20 may be physically present inside or outside the network device 100. Also, the network device 100 may include an input interface 110, a query list manager 120, a packet-stream converter 130, a query inquiry unit 140, a logical calculator 150, an operation performer 160, and an output interface 170.

Referring to FIG. 2, the respective components of the network device 100 for processing a complex event according to an example embodiment of the present invention and relationships between the components may be described as follows.

First, the controller 20 transmits a CQL-based query message to the query list manager 120. Here, the query message is transmitted along a physically or logically different path from that of a general data packet.

The query list manager 120 may receive the CQL-based query message from the controller 20, store a query in a memory, and manage the query in a query list such that the query can be rapidly searched for. For example, when the content for an event timer is included in the message received from the controller 20, the query list manager 120 resets an event timer 121.

The packet-stream converter 130 may be configured to decode a packet input through the input interface 110, and the query inquiry unit 140 may be configured to request and acquire a query message corresponding to the packet decoded by the packet-stream converter 130 from the query list manager 120. Also, the packet-stream converter 130 performs application layer decoding for the packet using the query list to identify a stream identification (ID) from header information of the decoded packet, and the query inquiry unit 140 acquires a query message corresponding to the identified stream ID through the query list manager 120.

For example, when a packet arrives at the input interface 110 of the network device 100, the packet-stream converter 130 decodes the packet. Basically, the packet is divided into an Ethernet header, an Internet protocol (IP) header, a transmission control protocol (TCP)/user datagram protocol (UDP) header, etc., and an application layer protocol also may be additionally decoded.

Application layer decoding may be performed with reference to the content of the query list managed by the query list manager 120. For example, when a specific IP address is a destination and a TCP port is a specific number, application layer decoding may be performed assuming that Sensor Markup Language (SensorML) is contained in Hypertext Transfer Protocol (HTTP). Also, since an application layer flow is divided into several packets and transmitted, the packet-stream converter 130 may also function to reassemble the application layer flow, and header information of the decoded packet may serve as a stream ID. Accordingly, the query inquiry unit 140 acquires a query sentence corresponding to the stream ID from the query list manager 120. Here, the query sentence may be one or more in number.

The logical calculator 150 may perform a logical calculation for determining an operation according to a condition specified in the acquired query message. Here, information on previous other streams is contained in a stream cache 161, and the result of the logical calculation may be stored in a result cache 163 for reuse.

The operation performer 160 may be configured to perform an operation of generating a message dependent on the logical calculation result or reconfiguring the packet according to the result of the logical calculation performed by the logical calculator 150, and transmitting the generated message or the reconfigured packet to an actuator or a surrounding network device through the output interface 170.

For example, a general operation according to the result of the logical calculator 150 may be “ignoring” or “forwarding to a server.” In other words, in an ordinary situation in which a specific condition is not satisfied, a default operation that is transmission to a server is performed. Accordingly, the output interface 170 is determined, and the packet may be reconfigured as needed and transmitted to the output interface 170. However, when the calculation result of the logical calculator 150 satisfies the condition specified in the query sentence, the operation specified in the query sentence may be performed. For example, it is possible to perform an operation of transmitting an alarm message to an alarm server node, or an operation of generating and transmitting a message that instructs to perform a specific operation to an actuator 300.

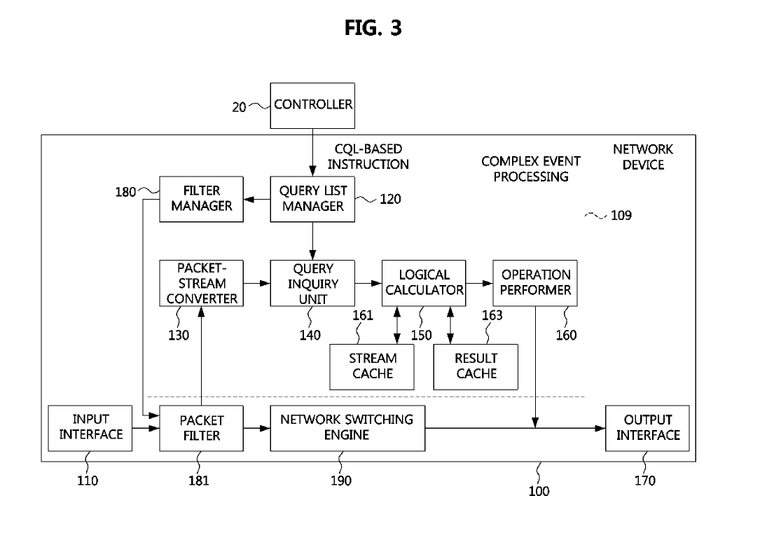

FIG. 3 is a block diagram of a network device for processing a complex event according to another example embodiment of the present invention.

Referring to FIG. 3, while the network device 100 of FIG. 2 converts all packets into streams and processes the streams, a network device 100 for processing a complex event according to another example embodiment of the present invention additionally includes a network switching engine 190 and a filter manager 180 and may be configured to process an event for only a packet satisfying a condition.

For example, when a continuous query sentence is registered by a controller 20, a query list manager 120 may request the filter manager 180 to add a packet filter, and the filter manager 180 adds a packet filter 181 in front of the network switching engine 190 according to a request of the query list manager 120 such that a packet input through an input interface 110 can pass an output interface 170 through the network switching engine 190 when the packet does not accord with the packet filter 181.

Thus, when packets are input to the input interface 110 after the packet filter 181 is added, a complex event is processed for only packets according with the packet filter 181. Such a structure is capable of hardware-based processing, and thus a packet that does not require complex event processing may be rapidly transferred through an existing network switching engine. Even in a complex event processing block 109, some or all components may be implemented as hardware for rapid processing using a field-programmable gate array (FPGA), application-specific integrated circuits (ASIC), and so on.

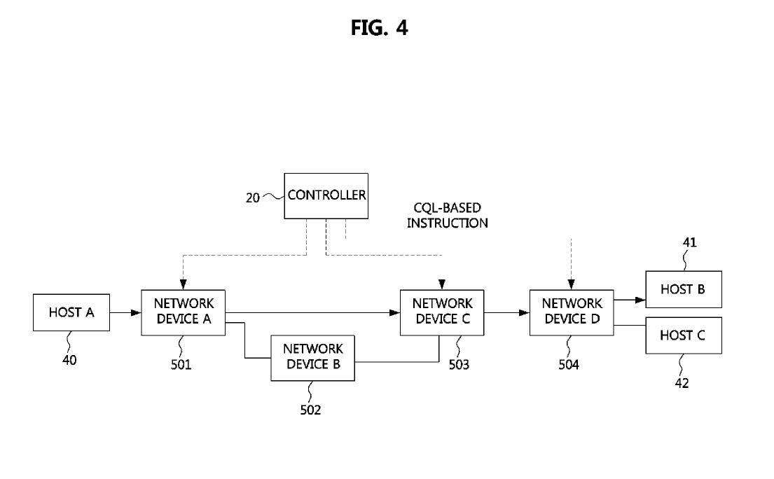

FIG. 4 is a conceptual diagram illustrating operation of a controller that controls network devices constituting a software-defined network (SDN) according to an example embodiment of the present invention.

Referring to FIG. 4, a controller 20 that controls network devices constituting an SDN according to an example embodiment of the present invention may be a device that controls the whole network, and software of the controller 20 may operate in connection with software on another layer.

Also, referring to FIG. 4, the controller 20 may set a special path other than a general packet routing path for inter-host communication. For example, when a request for a path from host a 40 to host b 41 is received, the controller 20 sets an optimal path. When “A-C-D” is set as the optimal path, the controller 20 gives a CQL-based instruction to network device A 501, network device C 503, and network device D 504 on the optimal path (A-C-D).

For example, the controller 20 may transmit a CQL-based instruction to “send a packet to network device C 503 when a source address of an IP header of the packet is host a, and a destination address is host b.” to network device A 501. In the message, a packet priority, a bandwidth, a virtual local area network (VLAN) tag ID, etc. may be specified.

In addition, the controller 20 transmits a similar CQL-based instruction to network device C 503 and network device D 504, too. Subsequently, when host a 40 transmits a packet to host b 41, the packet is forwarded not through a general path (A-B-C-D) but through the optimal path (A-C-D) set by the controller 20. Such a path selection and control may be determined according to the controller 20 and an algorithm of software operating in connection with the controller 20.

FIG. 5 is a block diagram of a network device constituting an SDN according to the example embodiment of FIG. 4.

Referring to FIG. 5, a network device 500 constituting an SDN according to the example embodiment of FIG. 4 may include an interface 510, a query list manager 520, a query-network transmission rule converter 530, a packet forwarding table 540, a routing table 550, a VLAN table 560, a network switching engine 590, and an output interface 570.

Referring to FIG. 5, the respective components of the network device 500 for processing a complex event according to an example embodiment of the present invention may be described as follows.

The query list manager 520 may be configured to receive a CQL-based instruction from the controller 20 described in FIG. 4 and manage the received CQL-based instruction in a query list.

In the packet forwarding table 540, next destination information on a packet received through the input interface 510 is stored, and in the VLAN table 560, VLAN configuration information for determining a tagging and forwarding path is stored. The query-network transmission rule converter 530 receives a query sentence from the query list manager 520, converts the received query sentence into a network transmission rule, and causes the packet forwarding table 540 and the VLAN table 560 to reflect the network transmission rule.

The network switching engine 590 is configured to refer to the packet forwarding table 540 and the routing table 550 to determine a next destination and process the packet when the packet arrives, and is configured to process the packet with reference to the VLAN table 560 when a VLAN is configured.

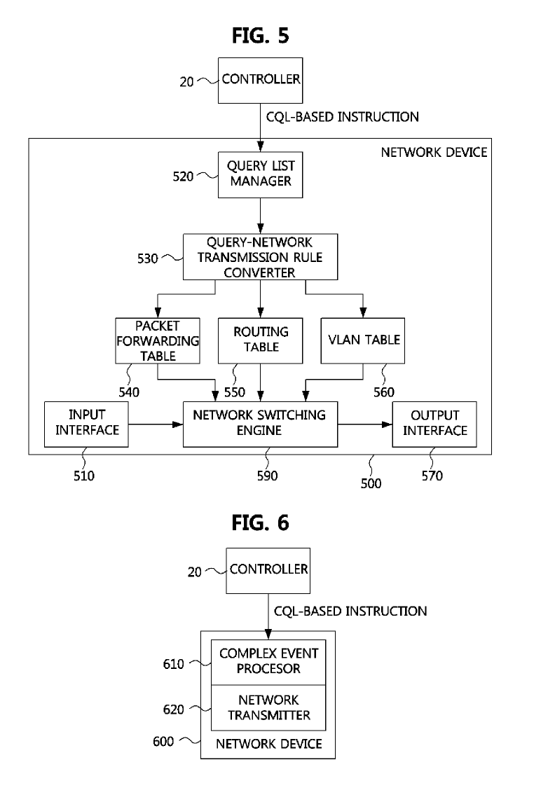

FIG. 6 is a block diagram of a network device constituting an SDN according to an example embodiment of the present invention.

Referring to FIG. 6, a network device 600 constituting an SDN according to an example embodiment of the present invention is configured to perform integrated functions of the network devices of FIG. 2, FIG. 3, and FIG. 5. In other words, the network device 600 may be configured to process a complex event as illustrated in FIG. 2 and FIG. 3 through a complex event processor 610 on the basis of a CQL-based instruction received from a controller 20, and also forward a packet as illustrated in FIG. 5 through a network transmitter 620.

Here, the controller 20 may be physically present inside or outside the network device 600. The controller 20 sets an event or network management rule using CQL or encoded CQL, and the complex event processor 610 may perform a logical calculation according to the set event or network management rule and perform an operation corresponding to the logical calculation result, for example, determination and change of a packet path, change of a packet/frame, generation of a new message, and ignoring of a packet/message.

CQL for network control (CQLn) according to an example embodiment of the present invention will be described in detail below.

It is difficult to handle a network packet or flow with general CQL for data stream processing. CQLn according to an example embodiment of the present invention has the following basic form:

SELECT select-list
FROM stream-list
WHERE match-condition

In the above sentence, “stream-list” following “FROM” denotes a list of data streams. At a network device, a data stream arrives in the form of a packet. A packet input to a network device consists of a media access control (MAC) header, an IP header, an UDP/TCP header, and application layer data. In general, flow in an IP network is identified using a bundle of a source IP address, whether or not TCP/UDP is used, a TCP/UDP port number, a destination IP address and protocol, and a port number. Thus, the bundle is managed as one stream ID.

For example, stream1 may be defined as follows:

pstream1 AS packet

To acquire a data stream of the application layer, the data stream may be defined as follows:

dstream2 AS data(pkt.dstip=2.2.2.2 AND pkt.dstport=80, decode_as=http/swe)

Several “stream-lists” may be listed and separated with commas.

“Match-condition” may follow “WHERE.” In CQLn, more operators, parentheses, and functions may be used compared to existing SQL, and it is possible to use a regular expression for string pattern matching. Also, a “RANGE” sentence capable of setting a range may be used, and a time range, the number of pieces of data, etc. may be set as a condition.

Examples of “match-condition” can be the following sentences:

pstream1.srcip=1.1.1.1 AND pstream1.dstip=2.2.2.2 AND
pstream1.dstport=8080
max(dstream1.sensor1.temp)>80 AND
average(dstream1.sensor1.humid)<10 RANGE

10min

“Select-list” follows “SELECT,” and a portion about “action” may be included unlike general SQL and CQL. For example, a packet may be processed as follows:

pkt as type, addtag 0x0101 as action, forward port 7 as action

When CQLn is forwarded as an actual instruction, CQLn may be forwarded in the form of XML or in a binary form including a query ID and “expire.” The following is an example of CQLn for changing a path of specific network traffic.

<subscribe>

<cqlId>MYCQLID1</cqlId>
<cql> SELECT packet, route_to 3.3.3.3 AS action

FROM ps1 AS packet
WHERE ps1.srcip=1.1.1.1 AND ps1.dstip=2.2.2.2

</cql>
<expires>1h</expires>

</subscribe>

The above continuous query sentence instructs to forward packets having a source IP address of 1.1.1.1 and a destination IP address of 2.2.2.2 to a router having an address of 3.3.3.3.

The following is an example of CQLn for processing a complex event of network traffic.

SELECT swe.alert(ds1.temp,http://7.7.7.7:8282) AS action
FROM ds1 AS data(pkt.dstip=2.2.2.2 AND pkt.dstport=80,
decode_as=http/swe)
WHERE max(ds1.sensor1.temp)>=80 AND
average(ds1.sensor2.humid)<10 RANGE

3min

The above query sentence instructs to analyze and parse a packet into an HTTP/sensor web enablement (SWE) sensor web flow, and transmit an alarm message to a server having an address of 7.7.7.7 when the content of the packet indicates that the highest temperature is 80 degrees Celsius or above and the average humidity is less than 10% for three minutes.

As another example, referring to FIG. 1, all messages generated by sensor nodes 200 may be basically transmitted to the server 10, and to this end, a process of setting an address of the server 10 for the sensor nodes 200 is needed. Such a setting process should be personally performed by an installer, takes a long time, and is a complicated operation.

Thus, when network devices 100 is set to transmit all packets received from ports connected to the sensor nodes 200 to the server 10, all the packets may be transmitted to the server 10 without a setting of the sensor nodes 200. An example of a CQLn sentence for this purpose is as follows:

SELECT packet, change dstip=2.2.2.2 AS action, forward default AS
action
FROM ps1 AS packet
WHERE ps1.inport>=1 AND ps1.inport<=3

When CQLn according to an example embodiment of the present invention is used to control a network device, various network configurations and services are enabled in easy connection with application service software, and it is possible to reduce network management/expansion cost.

When the above-described network control system according to an example embodiment of the present invention is used, in a sensor data collection, analysis, and processing process, a server does not perform data analysis and processing, but a network device on a path analyzes and controls data, such that an event can be rapidly detected and processed.

In addition, by allowing a controller to detect an event from sensor data, control the event, and also control a network path in a consistent way, an integrated network control and management system is provided.

While the example embodiments of the present invention and their advantages have been described in detail, it should be understood that various changes, substitutions and alterations may be made herein without departing from the scope of the invention.

What is claimed is:

1. A network device, comprising:
a query list manager configured to store a continuous query language (CQL)-based query message received through a controller connected to a central server in a memory, and manage the stored CQL-based query message in a query list;
a packet-stream converter configured to decode a packet input through an input interface;
a query inquiry unit configured to acquire a query message corresponding to the decoded packet through the query list manager;
a logical calculator configured to perform a logical calculation for determining an operation according to a condition specified in the acquired query message; and
an operation performer configured to perform an operation according to the logical calculation result.

2. The network device of claim 1, wherein the packet-stream converter performs application layer decoding for the packet using the query list and identify a stream identification (ID) from header information of the decoded packet, and
the query inquiry unit acquires the query message corresponding to the stream ID through the query list manager.

3. The network device of claim 1, wherein the operation performer performs an operation of generating a message according to the logical calculation result or reconfiguring the packet, and transmitting the generated message or the reconfigured packet to an actuator or a surrounding network device through an output interface.

4. The network device of claim 1, further comprising an event timer,
wherein the query list manager resets the event timer on the basis of the query message received through the controller.

5. The network device of claim 1, further comprising:
a filter manager; and
a network switching engine,
wherein the filter manager adds a packet filter in front of the network switching engine when a packet filter addition request is received from the query list manager, such that the packet input through the input interface passes the network switching engine to an output interface when the packet does not accord with the packet filter.

6. A controller for controlling at least one network device constituting a software-defined network (SDN), wherein, when a request for a path from a first host to a second host is received, an optimal path is set to give a continuous query language (CQL)-based instruction to respective network devices on the optimal path,
network devices closest to the respective network devices on the optimal path are identified, and
an instruction to transmit a packet having the first host as a source address and the second host as a destination address to the identified closest network devices when the packet is received is given to the respective network devices.

7. The controller of claim 6, wherein the instruction includes at least one of a packet priority, a bandwidth, and a virtual local area network (VLAN) tag identification (ID).

8. The controller of claim 6, wherein each of the network devices includes:
a routing table;
a packet forwarding table configured to store next destination information on a packet received through an input interface;
a query list manager configured to receive the CQL-based instruction from the controller and manage the CQL-based instruction in a query list;
a query-network transmission rule converter configured to receive a query sentence from the query list manager, convert the query sentence into a network transmission rule, and cause the packet forwarding table to reflect the network transmission rule; and
a network switching engine configured to process the packet with reference to the packet forwarding table and the routing table.

9. The controller of claim 8, wherein, when a virtual local area network (VLAN) is configured, each of the network devices further includes a VLAN table configured to store VLAN configuration information for determining a tagging and forwarding path,
wherein the network switching engine processes the packet with reference to the VLAN table as well.

10. The controller of claim 8, wherein an event condition and an instruction describing an operation according to the event condition are received from a central server and forwarded to each of the network devices, such that each of the network devices analyzes sensor data of the network device itself or a message received from each surrounding network device on the basis of the instruction received through the controller and performs the operation according to the event condition when the event condition is satisfied.

11. A network control system, comprising:
at least one event processing network connected to a central server,
wherein each of the event processing network is configured to receive an event condition and an instruction describing an operation according to the event condition from the central server, analyze sensor data of the event processing network itself or a message received from a surrounding event processing network on the basis of the instruction given by the central server, and perform the operation according to the event condition when the event condition is satisfied.

12. The network control system of claim 11, wherein each of the event processing network includes a network device configured to operate in connection with at least one sensor node and an actuator,
wherein the sensor node forwards sensor data sensed by a sensor to the network device, and
the network device analyzes the sensor data received from the sensor node or a message received from a surrounding network device on the basis of the instruction from the central server, and generates and forwards an operation message according to the event condition to the actuator or the surrounding network device when the event condition is satisfied.

13. The network control system of claim 12, wherein the network device includes:
a query list manager configured to receive a continuous query language (CQL)-based query message from a central server through a controller, store the received CQL-based query message in a memory, and manage the stored CQL-based query message in a query list;
a packet-stream converter configured to decode a packet input through an input interface;
a query inquiry unit configured to acquire a query message corresponding to the decoded packet through the query list manager;
a logical calculator configured to perform a logical calculation for determining an operation according to a condition specified in the acquired query message; and
an operation performer configured to perform an operation according to the logical calculation result.

14. The network control system of claim 13, wherein the packet-stream converter performs application layer decoding for the packet using the query list and identify a stream identification (ID) from header information of the decoded packet, and
the query inquiry unit acquires the query message corresponding to the stream ID through the query list manager.

15. The network control system of claim 13, wherein the operation performer performs an operation of generating a message according to the logical calculation result or reconfiguring the packet, and transmitting the generated message or the reconfigured packet to the actuator or the surrounding network device through an output interface.

16. The network control system of claim 13, wherein the network device further includes an event timer,
wherein the query list manager resets the event timer on the basis of the query message received through the controller.

17. The network control system of claim 13, wherein the network device further includes:
a filter manager; and
a network switching engine,
wherein the filter manager adds a packet filter in front of the network switching engine when a packet filter addition request is received from the query list manager, such that the packet input through the input interface passes the network switching engine to an output interface when the packet does not accord with the packet filter.

18. The network control system of claim 11, further comprising a controller configured to forward the continuous query language (CQL)-based query message to each of the event processing network.

19. The network control system of claim 18, wherein, when a request for a path from a first host to a second host is received, the controller sets a shortest path and forwards a CQL-based instruction to respective network devices on the shortest path, and
the controller identifies network devices closest to the respective network devices on the optimal path, and forwards an instruction to transmit a packet having the first host as a source address and the second host as a destination address to the identified closest network devices when the packet is received to the respective network devices,
